(19) United States
(12) Patent Application Publication
(10) Pub. No.: US 2026/0154571 A1
(43) Pub. Date: Jun. 4, 2026

(54) CODE KNOWLEDGE GRAPH GENERATION METHOD AND APPARATUS, CODE GENERATION METHOD AND APPARATUS, DEVICE, AND MEDIUM

(71) Applicant: Beijing Baidu Netcom Science Technology Co., Ltd., Beijing (CN)

(72) Inventors: Bingfei ZHANG, Beijing (CN); Junwei XING, Beijing (CN); Yunpeng PENG, Beijing (CN); Zhi ZANG, Beijing (CN); Xiangfei MIN, Beijing (CN); Yuxuan WEN, Beijing (CN); Ziwei JIN, Beijing (CN); Yuehao ZHAO, Beijing (CN); Wenqing XU, Beijing (CN)

(21) Appl. No.: 19/088,370

(22) Filed: Mar. 24, 2025

(30) Foreign Application Priority Data
Dec. 4, 2024 (CN) 202411775261.0

(51) Int. Cl. G06N 5/022; G06F 8/33

(52) U.S. Cl. CPC G06N 5/022; G06F 8/33

(57) ABSTRACT

A code knowledge graph generation method and apparatus, a code generation method and apparatus, a device, and a medium, relate to the field of data processing, specifically the technical fields of intelligent search, human-computer interaction, artificial intelligence, and large language models. The specific implementation solution includes acquiring a code tree, where the code tree includes first code elements and a structural relationship among the first code elements, where the code tree is generated by performing content parsing on a source code; generating at least one first graph node according to the first code elements; generating a first graph edge between corresponding graph nodes according to the structural relationship; generating a code knowledge graph according to the at least one first graph node and the first graph edge.

### CROSS-REFERENCE TO RELATED APPLICATIONS

This application claims priority to Chinese Patent Application No. CN202411775261.0 filed Dec. 4, 2024, the disclosure of which is incorporated herein by reference in its entirety.

### TECHNICAL FIELD

The present disclosure relates to the field of data processing, specifically the technical fields of intelligent search, human-computer interaction, artificial intelligence, and large language models, and, in particular, to a code knowledge graph generation method and apparatus, a code generation method and apparatus, a device, and a medium.

### BACKGROUND

A large language model (LLM) may generate codes.

With the rapid development of multimodal large language models, efficiently and automatically evaluating the generation quality and performance of these models in practical applications has become a key issue currently.

In the field of code intelligence understanding and generation, enhancing LLM based on retrieval-augmented generation (RAG) can enrich contextual depth in searching manners such as a vector semantic search and a keyword-based full-text search while ensuring the timeliness and accuracy of relevant knowledge, which can alleviate problems such as hallucinations and insufficient contextual message to some extent.

### SUMMARY

The present disclosure provides a code knowledge graph generation method and apparatus, a code generation method and apparatus, a device, and a medium.

According to an aspect of the present disclosure, a code knowledge graph generation method is provided. The code knowledge graph generation method includes the steps below.
A code tree is acquired, where the code tree includes first code elements and a structural relationship among the first code elements, where the code tree is generated by performing content parsing on a source code.
At least one first graph node is generated according to the first code elements.
A first graph edge between corresponding graph nodes is generated according to the structural relationship.
A code knowledge graph is generated according to the at least one first graph node and the first graph edge.

According to an aspect of the present disclosure, a code generation method is provided. The code generation method includes the steps below.
An input question message is acquired.
A search is performed in a code knowledge graph according to the question message to obtain target code knowledge, where the code knowledge graph is generated by the code knowledge graph generation method provided in any embodiment of the present disclosure.
An answer message is generated according to the target code knowledge and the question message.

According to an aspect of the present disclosure, a code knowledge graph generation apparatus is provided. The code knowledge graph generation apparatus includes the modules below.
A code tree acquisition module is configured to acquire a code tree, where the code tree includes first code elements and a structural relationship among the first code elements, where the code tree is generated by performing content parsing on a source code.
A graph node generation module is configured to generate at least one first graph node according to the first code elements.
A graph edge generation module is configured to generate a first graph edge between corresponding graph nodes according to the structural relationship.
A knowledge graph construction module is configured to generate a code knowledge graph according to the at least one first graph node and the first graph edge.

According to an aspect of the present disclosure, a code generation apparatus is provided. The code generation apparatus includes the modules below.
A question acquisition module is configured to acquire an input question message.
A knowledge search module is configured to perform a search in a code knowledge graph according to the question message to obtain target code knowledge, where the code knowledge graph is generated by the code knowledge graph generation method provided in any embodiment of the present disclosure.
An answer generation module is configured to generate an answer message according to the target code knowledge and the question message.

According to another aspect of the present disclosure, an electronic device is provided. The electronic device includes at least one processor; and a memory communicatively connected to the at least one processor, where the memory is configured to store instructions executable by the at least one processor to cause the at least one processor to perform the code knowledge graph generation method provided in any embodiment of the present disclosure or the code generation method provided in any embodiment of the present disclosure.

According to another aspect of the present disclosure, a non-transitory computer-readable storage medium is provided. The non-transitory computer-readable storage medium stores computer instructions configured to cause a computer to perform the code knowledge graph generation method provided in any embodiment of the present disclosure or the code generation method provided in any embodiment of the present disclosure.

According to another aspect of the present disclosure, a computer program product is provided. The computer program product includes a computer program which, when executed by a processor, is configured to cause the processor to perform the code knowledge graph generation method provided in any embodiment of the present disclosure or the code generation method provided in any embodiment of the present disclosure.

Therefore, the integrity of the knowledge graph can be increased, the storage amount and data processing amount of the knowledge graph can be reduced, and the construction efficiency of the knowledge graph can be improved.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

The drawings are intended to provide a better understanding of the solutions and not to limit the present disclosure.

FIG. 1 is a flowchart of a code knowledge graph generation method according to an embodiment of the present disclosure.

FIG. 2 is a schematic diagram of a code knowledge graph construction scenario according to an embodiment of the present disclosure.

FIG. 3 is a schematic diagram of a code knowledge graph according to an embodiment of the present disclosure.

FIG. 4 is a flowchart of a code generation method according to an embodiment of the present disclosure.

FIG. 5 is another flowchart of a code generation method according to an embodiment of the present disclosure.

FIG. 6 is a scenario diagram of a code knowledge search method according to an embodiment of the present disclosure.

FIG. 7 is a scenario diagram of a code generation method according to an embodiment of the present disclosure.

FIG. 8 is a schematic diagram illustrating the structure of a code knowledge graph generation apparatus according to an embodiment of the present disclosure.

FIG. 9 is a schematic diagram illustrating the structure of a code generation apparatus according to an embodiment of the present disclosure.

FIG. 10 is a block diagram of an electronic device for a code knowledge graph generation method according to an embodiment of the present disclosure.

### DETAILED DESCRIPTION

Example embodiments of the present disclosure, including details of embodiments of the present disclosure, are described hereinafter in conjunction with the drawings to facilitate understanding. The example embodiments are illustrative only. Therefore, it is to be appreciated by those of ordinary skill in the art that various changes and modifications may be made to the embodiments described herein without departing from the scope and spirit of the present disclosure. Similarly, description of well-known functions and constructions is omitted hereinafter for clarity and conciseness.

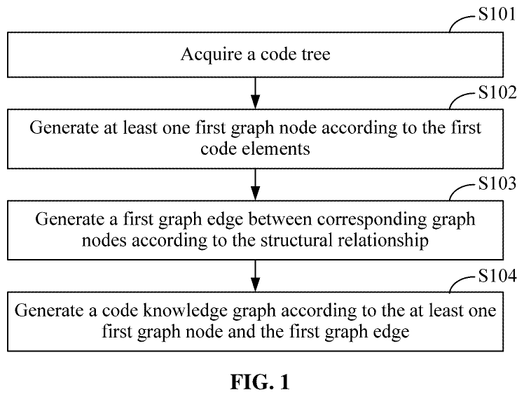

FIG. 1 is a flowchart of a code knowledge graph generation method according to an embodiment of the present disclosure. This embodiment is applicable to the case of constructing a knowledge graph. The method of this embodiment may be executed by a code knowledge graph generation apparatus. The apparatus may be implemented by software and/or hardware and is specifically configured in an electronic device having a certain data computing capability. The electronic device may be a server device.

In S101, a code tree is acquired, where the code tree includes first code elements and a structural relationship among the first code elements, where the code tree is generated by performing content parsing on a source code.

The code tree may refer to a tree describing the structural relationship among the first code elements. The first code element may refer to a basic unit that constitutes the code structure and behavior in the source code. The structural relationship among the first code elements may refer to the relationship of interaction and connection between the first code elements. Nodes in the tree are the first code elements, and the relationship between the nodes is the structural relationship among the first code elements. In some embodiments, the first code element includes at least one of file, class, parent class, interface, method, field, parameter passing, return type, invoking, or type. The structural relationship may include a dependency relationship, an inclusion relationship, or a description relationship. The code tree may perform the content parsing on the source code to obtain the code elements included in the source code and the structural relationship among the code elements, and use the code elements and the structural relationship as the first code elements and the structural relationship among the first code elements.

It is to be noted that the code tree is configured to form a code knowledge graph. The source code is parsed at a coarse granularity to construct the code tree, and then the code knowledge graph is generated according to the constructed code tree. In this manner, as intermediate data for forming the code knowledge graph, the code tree can reduce the data computing amount at the current end.

In addition, the source code may be uploaded by a client to the current end, or the current end acquires an authorized open source code and constructs the code tree based on the acquired source code. Alternatively, the source code may be a client end's local code; the client end may process the source code to generate the code tree and send the code tree to the current end; the current end generates the code knowledge graph, which can prevent the current end from directly acquiring the client's local code, improving the security of the local code.

In S102, at least one first graph node is generated according to the first code elements.

Each of the at least one first graph node may include a first graph node and an associated message of the first graph node. One first code element is used as one first graph node, an extractable message of the first code element in the source code is used as the associated message of the first graph node, and the first graph node and the associated message generate each of the at least one first graph node. In some embodiments, the associated message may include an attribute message of the first code element and the position of the first code element in the source code.

In S103, a first graph edge between corresponding graph nodes is generated according to the structural relationship.

The first graph edge may include first graph nodes connected by a first graph edge, the direction of the first graph edge, and the relationship represented by the first graph edge. The first graph edge is created for the first graph nodes corresponding to the first code elements with a structural relationship to connect the corresponding first graph nodes. The first graph edge represents that the structural relationship exists between the first code elements represented by the first graph nodes connected by the first graph edge. The first graph edge may be a directed line. Exemplarily, the first graph edge between first graph nodes corresponding to two first code elements with a dependency relationship has a direction from one first graph node being relied upon to the other first graph node. For another example, the first graph edge between first graph nodes corresponding to two first code elements with an inclusion relationship has a direction from a first graph node with a large range to a first graph node with a small range (being included). For another example, the first graph edge between first graph nodes corresponding to two first code elements with a hierarchical relationship has a direction from an upper first graph node to a lower first graph node.

In S104, a code knowledge graph is generated according to the at least one first graph node and the first graph edge.

The code knowledge graph includes the first graph nodes and the first graph edge representing the relationship between two first graph nodes. The first graph nodes are created according to the at least one first graph node, and the two connected first graph nodes are queried according to the first graph edge; the first graph edge is created between the two connected first graph nodes; the direction of the first graph edge is determined according to the at least one first graph node and/or the first graph edge. By directly extracting the first code elements and the structural relationship from the source code, an unprocessed code message may be acquired, and a continuous relationship message may be acquired at the same time, which can avoid the loss of data due to the processing of the code message, thus avoiding message loss in the code knowledge graph. In addition, extracting the first code elements and the structural relationship from the source code and deleting messages such as redundant annotations can compress the code content and reduce redundant data.

In addition, the source code further includes first code elements of other coding scopes outside the current coding scope, the structural relationship among the first code elements, and the first code elements of the current coding scope. For example, one method in one source code file invokes a method in another source code, and a code tree corresponding to the former source code includes methods in the latter source code and the relationship between two methods. Therefore, the code tree constructed based on the source code includes the first code elements of other coding scopes so that a global message can be completed in the code knowledge graph constructed in this manner, and so that the code tree can have a complete and rich code message, thereby enriching the messages in the code knowledge graph.

In the embodiment of the present disclosure, the code knowledge graph is configured to perform a search based on a question message to obtain code knowledge when LLM performs human-computer interaction, so as to assist LLM in understanding the question message and generating an answer message required by the client.

According to the technical solutions of the present disclosure, the content parsing is performed on the source code, the code elements and the structural relationship are extracted from the source code, the code tree is generated based on the extracted content, and the code knowledge graph is generated based on the code tree so that the processing of the code elements and the structural relationship can be reduced, and the loss of valid data in the code knowledge graph can be reduced. Moreover, a redundant message in the source code can be deleted to streamline the code knowledge graph; the storage amount and data processing amount of the knowledge graph can be reduced, and the construction efficiency of the knowledge graph can be improved; the code elements of the other scopes involved in the source code can also be acquired to increase the global message, thereby increasing the integrity of the knowledge graph.

In an optional embodiment, the code knowledge graph generation method further includes acquiring a description message associated with the code tree; adding the description message to the code knowledge graph.

The description message may refer to a description message of the source code in terms of function or business. Adding the description message to the code knowledge graph can increase the natural language content in the code knowledge graph. Exemplarily, the description message may include at least one of a submission message of the source code, a merge message of the source code, and a tag message of the source code. The description message may be a text message or an annotation that is related to the source code. As a representation of the natural language content of the source code, the description message may assist in understanding the first graph nodes and the first graph edge in the code knowledge graph.

The description message of the source code configured to generate the code tree may be acquired. The description message may include a sub-message of each of at least one first code element and/or a sub-message of each of at least one structural relationship. The sub-messages are added to the corresponding positions in the code knowledge graph according to the at least one first code element and/or the at least one structural relationship associated with the sub-messages in the description message. In some embodiments, the description message of the source code may also be acquired, and the code tree is generated based on the description message and the source code; the sub-messages in the description message are used as the code elements of the code tree. In this manner, the description message exists in the code knowledge graph generated based on the code tree.

Adding the description message associated with the code tree to the code knowledge graph can add a business service message to the code knowledge graph, which is closer to the client's natural language and improves the convenience of a search.

In an optional embodiment, adding the description message to the code knowledge graph includes generating a second graph node according to the description message; adding the second graph node to the code knowledge graph; acquiring a second code element corresponding to the description message; generating, in the code knowledge graph, a second graph edge between the second graph node and a first graph node corresponding to the second graph node; adding the second graph edge to the code knowledge graph. The second graph node may include a second graph node and an associated message of the second graph node. The second graph edge may include the second graph node and a first graph node that are connected by a second graph edge, the direction of the second graph edge, and the relationship represented by the second graph edge. The direction of the second graph edge is from the connected first graph node to the connected second graph node. The relationship represented by the second graph edge is a relationship describing a business message. The description message is used as one second graph node, and the second graph edge is established between first graph nodes corresponding to a described object. The description message includes at least one sub-message. One sub-message generates one second graph node, a first code element described by the sub-message is acquired, and the second graph edge is created between the second graph node generated by the sub-message and a first graph node generated by the described first code element; the direction of the second graph edge is from the first graph node to the second graph node.

Using the description message as a code element and a node in the code knowledge graph increases the importance of the description message in the code knowledge graph and improves the convenience of the search of the description message.

In an optional embodiment, the code tree is generated by performing the content parsing on a source code with a specified target range, and the target range includes a source file, a codebase, or a directory.

The source code may be provided by the client. The source code may be a source code in one source file, may be a source code in a codebase, or may be a source code stored in a certain directory.

In some embodiments, a code development application is installed locally on the client end, and a target plug-in is configured in the code development application. The client specifies the target range through the target plug-in of the client end, and the target plug-in of the client end processes the source code with the target range to generate the code tree and sends the code tree to a server end. The server end generates the code knowledge graph according to the code tree. The target range may be a local source file, a local codebase, or a local directory.

In some embodiments, the client specifies the target range through a network end (a web end), and the network end processes the source code with the target range to generate the code tree and sends the code tree to the server end. The server end generates the code knowledge graph according to the code tree. The target range may be a network source file, a network codebase, or a network uniform resource locator address (directory).

In addition, the client end may generate one corresponding code tree for each source file. When the client specifies multiple source files, code trees corresponding to the multiple source files may be sent to the current electronic device. The code tree is a tree with file granularity. One codebase may include the multiple source files, or one directory may store the multiple source files. The current electronic device generates the code knowledge graph according to multiple code trees.

Configuring the code tree to be generated based on the source code with the target range specified by the client can improve the flexibility and diversity of the code knowledge graph.

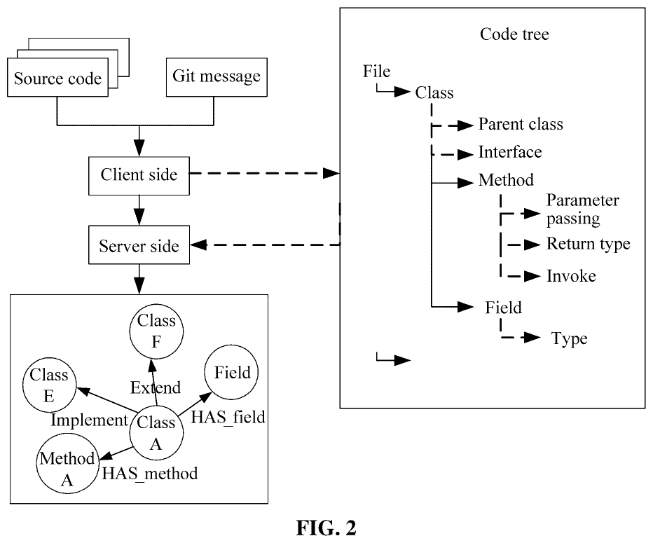

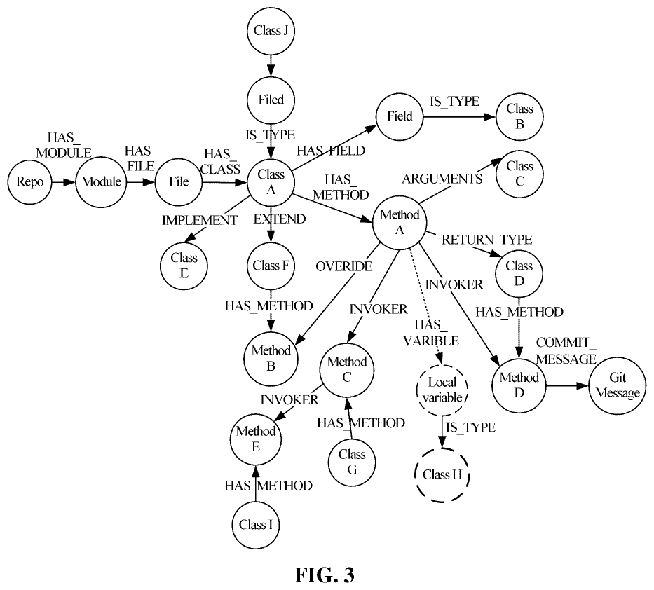

In some embodiments, FIG. 2 provides a scenario diagram of a code knowledge graph generation method. The Scheme of the generated code knowledge graph is shown in FIG. 3 by analyzing tens of thousands of the client's real request scenarios and abstracting the structure of the source code. In the construction stage of the code knowledge graph, the construction of the code tree is completed with the help of the syntax analysis capability of an integrated development environment (IDE) of the client end. At this stage, the Scheme of the knowledge graph (points and edges in the graph) is first required for clarity, and a knowledge graph at a codebase level is constructed on the basis of constructing a traditional vector index.

Different from the conventional process of chunk fragmentation and local analysis, the codebase is naturally one or more “graphs” but is not limited to a certain file, class, or method. This requires the capability to parse the entire base to construct the entire knowledge graph at the codebase level.

An IDE end, that is, the client end, has the complete syntax parsing capability but heavily relies on the performance and version of a client terminal. High-load parsing affects the client experience. Therefore, the IDE performs preliminary parsing, allows each source file to obtain a graph tree (GraphTree) as an intermediate representation, and focuses on parsing dependencies such as symbol references that the server end cannot handle well. As shown in FIG. 2, the graph tree is the code tree. In the graph tree, the next level of file is class. The next level of class includes parent class, interface, method, and field. The next level of method includes parameter passing, return type, and invoking. The next level of field is type and others.

The server end converts the GraphTree into a point and edge form acceptable to the graph and further processes more complex deep-level relationships such as generic dependencies, inner classes, and Git diff (differences between different versions). In the formed code knowledge graph shown in FIG. 2, class A directs to class E, class F, method A, and field. Class A may invoke and implement class E and extend class F. Class A includes method A (HAS_method) and field (HAS_field). In the code tree, solid arrows represent entity hierarchical relationships, and dotted arrows represent attribute directional relationships.

In an example of the code knowledge graph, as shown in FIG. 3, one code repository (repo) directs to one module; the module directs to a file; the file directs to class A. In addition, in the code tree, there are other files directing to class A. For example, class J directs to one file; the file directs to class A. Class A directs to a different file from the preceding, and the file directs to class B. In fact, the code tree is generated based on one source file, but classes included in the source file may have a structural relationship with classes in other files, which may also be reflected in the code tree. In this manner, the structural relationships of more other files can be completed in the code tree based on the one source file. Class A directs to class E, class F, and method A. Class F directs to method B. Method A directs to method B, method C, method D, class C, class D, and local variable. Method C directs to method E. Class I directs to method E. Class G directs to method C. Class D directs to method D. Method D directs to the description message (git message). Local variable directs to class H.

In the embodiment of the present disclosure, most of the graph nodes in the code knowledge graph constructed based on the code tree correspond to entities in the source code, and such an intuitive conversion facilitates the conversion from code-related natural language queries to graph queries. The git message in the source file is acquired, the graph nodes are generated, and the relationship between a document and code is retained; this part of the document is closer to the client's natural language. The code tree retains direct dependencies and deep-level dependencies in the source code as much as possible. The code tree may be calculated through online transaction processing (OLTP) and online analytical processing (OLAP) of a graph database, the code tree can be generated locally, and the code knowledge graph can be generated at the server end, which prevents a server from directly acquiring the source code to generate the graph, implements the online generation of the code knowledge graph, and reduces the load pressure of graph construction and graph updating at the server end.

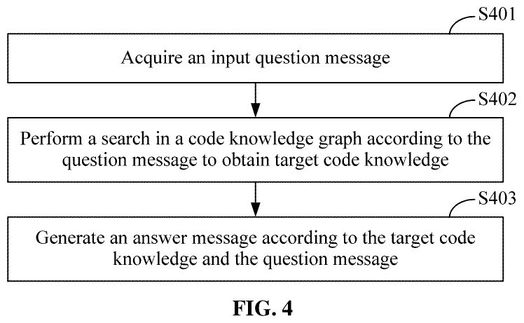

FIG. 4 is a flowchart of a code generation method according to an embodiment of the present disclosure. This embodiment is applicable to the case of human-computer interaction based on the knowledge graph constructed in the preceding embodiment. The method of this embodiment may be executed by a code generation apparatus. The apparatus may be implemented by software and/or hardware and is specifically configured in an electronic device having a certain data computing capability. The electronic device may be a server device.

In S401, an input question message is acquired.

In the human-computer interaction scenario, the client provides the question message, and the current electronic device processes the question message to obtain the answer message. The question message is natural language content, and the language and media types of the question message are not limited.

In S402, a search is performed in a code knowledge graph according to the question message to obtain target code knowledge, where the code knowledge graph is generated by the code knowledge graph generation method provided in any embodiment of the present disclosure.

The code knowledge graph is configured to provide the target code knowledge. Relevant knowledge is searched in the code knowledge graph according to the question message to obtain code knowledge. The code knowledge is configured to assist the current electronic device in processing the question message. The target code knowledge may include the graph nodes, the graph edges, and the structural relationships between the preceding elements in the code knowledge graph. The graph nodes may include the first graph nodes and the second graph node in the preceding embodiment, and the graph edges may include the first graph edge and the second graph edge in the preceding embodiment.

In S403, an answer message is generated according to the target code knowledge and the question message.

In some embodiments, the target code knowledge and the question message are integrated and input into LLM for processing, and the answer message is output. Specifically, the target code knowledge and the question message may be added to a prompt template, the prompt template after the addition is input into LLM for processing, and the answer message is output.

In some embodiments, the application scenario of human-computer interaction is to generate a code based on the question message. The question message is a code.

According to the technical solutions of the present disclosure, the target code knowledge related to the question message is searched in the constructed code knowledge graph, and the question message is processed in combination with the target code knowledge to obtain the answer message; the code knowledge can be searched in the code knowledge graph that retains the original code elements and deletes the redundant message so that the limited code knowledge can include richer key messages, helping understand the overall code architecture and improving the reliability of the answer message.

In an optional embodiment, generating the answer message according to the target code knowledge and the question message includes sorting search results included in the target code knowledge according to the question message to obtain a sorting result; generating the answer message according to the sorting result and the question message.

The target code knowledge includes at least one search result. The search results may be sorted according to the correlation between the search results and the question message to obtain the sorting result. In the target code knowledge directly searched, the search results are arranged in random order, and the sorting result may refer to the code knowledge after the search results are sorted. In fact, the arrangement order of the search results in the code knowledge before sorting may be the expected sorting order, that is, the arrangement order of the search results in the re-sorted code knowledge may be the same as the arrangement order of the search results in the code knowledge before sorting. The sorting result actually includes the correlation between the search results and the question message. Generating the answer message according to the sorting result and the question message is equivalent to generating the answer message according to the target code knowledge, the correlation between the search results and the question message in the target code knowledge, and the question message.

In some examples, the correlation between the search results and the question message may be determined based on the search manners of the search results and the confidence of the search results under the search manners. For another example, the similarity between the search results and the question message may be directly calculated and used as the correlation between the search results and the question message.

In some embodiments, the prompt template includes a question slot and a code knowledge slot; the question message is added to the question slot, the sorting result is added to the code knowledge slot, the prompt template after the addition of the question message and the sorting result is input into LLM, and the answer message is output. The search results in the prompt template are added in arrangement order.

The search results in the code knowledge are sorted according to the question message to obtain the sorted code knowledge so that the code knowledge can contain the relationship order between the code knowledge and the question message. Moreover, the answer message is generated based on the sorted code knowledge and the question message, which can assist the device in using more relevant code knowledge to answer the question message and obtain the answer message.

In an optional embodiment, the code generation method further includes acquiring a code tree generated based on a specified local source code; acquiring the code knowledge graph according to the code tree.

The code tree generated based on the specified local source code may be acquired while acquiring the input question message, that is, the client may input both the question message and the source code with a specified target range. In some embodiments, the client end or the network end generates the code tree based on the source code with the target range and sends the question message and the code tree to the current electronic device. The current electronic device receives the question message and the code tree generated by the source code with the target range. The current electronic device generates the code knowledge graph according to the code tree and searches the code knowledge in the code knowledge graph generated according to the question message. The answer message is generated according to the question message and the code knowledge. Configuring the code knowledge graph to be generated based on the source code with the target range specified by the client can improve the adaptability of the code knowledge graph to the question message, increase the representativeness of the code knowledge, and increase the correlation with the question message, thereby improving the accuracy of the answer.

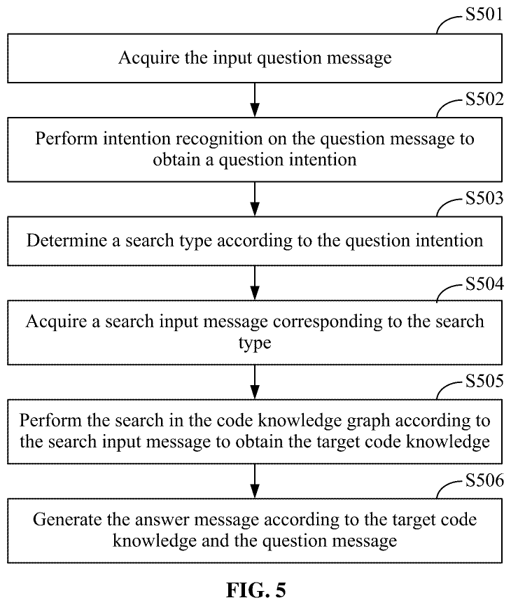

FIG. 5 is another flowchart of a code generation method according to an embodiment of the present disclosure. The code generation method is further optimized and extended based on the preceding technical solution and may be combined with the preceding various optional embodiments. Performing the search in the code knowledge graph according to the question message to obtain the code knowledge specifically includes performing intention recognition on the question message to obtain a question intention; determining the search type according to the question intention; acquiring a search input message corresponding to the search type; performing the search in the code knowledge graph according to the search input message to obtain the code knowledge.

In S501, the input question message is acquired.

In S502, intention recognition is performed on the question message to obtain a question intention. The question message may be semantically understood to obtain the question intention. In some embodiments, LLM may be used for performing the intention recognition on the question message. A prompt template with the intention recognition function is used for integrating the question message with the prompt template with the intention recognition function and inputting the integration into LLM to obtain the question intention.

In S503, the search type is determined according to the question intention.

The search type is configured to determine a search manner and may also include a to-be-searched data source. In fact, the question intention includes the knowledge required to answer the question message, the data source where the required knowledge is located, and the search manner to acquire the required knowledge. The to-be-searched data source and the search manner may be acquired according to the question intention, and the search type is determined according to the to-be-searched data source and the search manner. Through the intention recognition, it may be determined how the question message needs to be searched in order to obtain the sufficient context.

In some embodiments, the search type may include a query statement search, an extended search, or other searches. For example, when the question message or the question intention is a precise search such as a query graph node search, a complex relationship search, a subgraph search, or a visualization search, the search type may be determined as the query statement search. For another example, when the question message or the question intention is a search that has more natural language content than a programming language, such as a descriptive content search of a business service or function, the search type may be determined as the extended search. The other types may be types that supplement the search type of the code knowledge graph. The other types may include a vector search that may encode the graph nodes and the graph edges in the code knowledge graph to form vectors, perform vector similarity calculations in the code knowledge graph according to vector representations corresponding to the question message and/or the question intention, and query related graph nodes and/or graph edges. In addition, the other types may also include a search type in a data source outside the code knowledge graph.

In S504, a search input message corresponding to the search type is acquired.

The search input message is a message on which the search is performed in the code knowledge graph. The search input message is generated in a manner corresponding to the search type.

In S505, the search is performed in the code knowledge graph according to the search input message to obtain the target code knowledge, where the code knowledge graph is generated by the code knowledge graph generation method provided in any embodiment of the present disclosure.

In some embodiments, the search type is the query statement search, and the corresponding search input message is at least one query statement. Each query statement is executed to obtain at least one search result in the code knowledge graph to generate the target code knowledge. For another example, the search type is the extended search, and the corresponding search input message is a keyword. Graph nodes and/or graph edges corresponding to the keyword are queried in the code knowledge graph. For another example, the search type is the other searches, and the corresponding search input message is a vector; graph nodes and/or graph edges corresponding to the vector are queried in the code knowledge graph. Alternatively, the search input message is a vector, and similar vectors are queried in a vector base of code elements to obtain code elements and associated messages that correspond to the similar vectors.

In S506, the answer message is generated according to the target code knowledge and the question message.

According to the technical solutions of the present disclosure, the question intention of the question message is recognized, the search type and the corresponding search input message are determined according to the question intention, and the search is performed in the code knowledge graph based on the search input message to obtain the target code knowledge so that the search type required to answer the question message can be parsed, the missing knowledge for answering the question message can be determined, and a search manner for acquiring the missing knowledge for answering the question message can be planned, and the target code knowledge can be obtained finally, thereby enabling autonomous search determination of a code knowledge answer task. Moreover, based on a tool of the code knowledge graph, a code knowledge search can be performed, the search feasibility determination can be increased, and the search accuracy can be improved, thereby improving the accuracy of the answer message.

In an optional embodiment, the search type includes the query statement search; acquiring the search input message corresponding to the search type includes generating a query statement according to the question message, where the search input message includes the query statement.

The code knowledge graph is actually a graph database and may be queried using a query statement of the graph database. The query statement is configured to query in the code knowledge graph. The query statement can be a query statement of the graph database. At least one query statement is provided.

In some embodiments, Text2Gremlin may be used for converting the question message into the query statement of the graph query language gremlin. For another example, the graph query language may be Cypher. In some embodiments, the question message may be added to a prompt template for generating a query statement, the prompt template for generating a query statement after the addition may be input into LLM for processing, and the query statement may be output.

Generating the query statement corresponding to the question message and using the query statement as the search input message for the query statement search type can add the statement query scenarios of the graph and rapidly and accurately position the code knowledge in the code knowledge graph.

In an optional embodiment, the search type includes the extended search; acquiring the search input message corresponding to the search type includes determining a key message according to the question message and the question intention, where the search input message includes the key message.

The extended search may refer to the type of a search of attributes of a graph node in the code knowledge graph. In some embodiments, the key message is matched with an attribute message of the graph node in the code knowledge graph. In some embodiments, keywords are extracted from the question message and the question intention respectively and are integrated to obtain the key message. For example, the question message may be rewritten according to the question message and the question intention to generate a series of related questions, and keywords may be extracted from the questions. Extracting the keywords from the questions may be segmenting the questions and supplementing, expanding, and transforming the segmentations according to the question intention to obtain a large number of keywords. The large number of generated keywords may also be screened according to the question message and the question intention to obtain the key message. The extended search provides the functions of key message and full-text searches.

Acquiring the key message of the question message as the search input message corresponding to the extended search type can expand the search scope and enrich the content of the search results. In addition, performing the search based on the attributes of the precise graph node in the code knowledge graph can reduce redundant search results and improve the search accuracy.

In an optional embodiment, performing the search in the code knowledge graph according to the search input message to obtain the target code knowledge includes performing the search in the code knowledge graph according to the search input message to obtain at least two target nodes; generating a subgraph according to the at least two target nodes and the association relationship between the at least two target nodes, where the target code knowledge includes the at least two target nodes and the subgraph.

Each of the at least two target nodes is a graph node searched based on the search input message. The association relationship may refer to the connection relationship between the at least two target nodes, and the connection relationship may be the structural relationship of code elements represented by the at least two target nodes. The subgraph may be formed by the at least two searched target nodes and the connection relationship between the at least two searched target nodes. The subgraph and the at least two target nodes are used as the target code knowledge.

In some embodiments, the subgraph is generated according to the at least two target nodes and edges between these target nodes. In some embodiments, the at least two target nodes may be expanded in the code knowledge graph to obtain more graph nodes, and the expanded graph nodes and these target nodes are used for jointly generating the subgraph.

In some embodiments, among the at least two target nodes, if there is a path that may communicate with two target nodes, graph nodes through which the communication path of the two target nodes passes are acquired. The target nodes and all the acquired graph nodes through which the communication path passes are used for generating the subgraph. In addition, the direction of the communication path may also be limited, and graph nodes passing in the direction of a path that satisfies the specified communication are acquired according to the directions of directed edges of the target nodes.

In an example, target node A and target node D are searched, and target node A may reach target node D by sequentially passing through graph node B and graph node C. Target node A, graph node B, graph node C, and target node D may be used for generating the subgraph.

In an example, target node A may reach target node D by sequentially passing through graph node B and graph node C on the outgoing edge communication path of target node A. The incoming edge communication path of target node A passes through graph node E, and the outgoing edge communication path of graph node E passes through target node F. Only target node A, graph node B, graph node C, and target node D may be used for generating the subgraph, while graph node E on the incoming edge path is not used as a node for generating the subgraph. An incoming edge is a graph edge directing to a graph node, and an outgoing edge is a graph edge of another graph node directed to by the graph node.

In some embodiments, for each target node, a preset number of graph nodes passing through a communication path in the specified direction of each target node may be acquired and added to the subgraph. Generating the subgraph through the target nodes searched from the code knowledge graph and the association relationship can enrich the deeper relationship between the code elements in the search results and increase the code structural relationship in the target code knowledge so that missing paths in the search results can be completed, thereby providing an answer based on the target code knowledge. In scenarios where LLM is used for human-computer interaction, a richer context and structural relationship are provided for LLM, which can enhance LLM's understanding of the code structural relationship and improve the accuracy of the answer message.

In an optional embodiment, the code generation method further includes outputting the question intention, the target code knowledge, and the answer message.

When the subgraph is generated, the target code knowledge includes the subgraph, thereby outputting the target code knowledge, that is, outputting the target nodes and the subgraph. The intermediate processing process of the question message is provided for the client by providing the client with the question intention, the target code knowledge, and the answer message, which can help the client understand the answer processing process, increase the understanding of the code structural relationship, improve the reliability of the answer message, and improve the client experience.

In an optional embodiment, performing the search in the code knowledge graph according to the search input message to obtain the target code knowledge includes matching the search input message with a graph node identifier of the code knowledge graph to obtain the target code knowledge, where the graph node identifier is an identification message of a code element in the source code configured to construct the code knowledge graph.

The node identifier may uniquely identify a graph node in the code knowledge graph. The node identifier may be the identification message of the code element that generates the identified graph node. The identification message may be a name. Matching the search input message with the node identifier may search the graph node of the node identifier corresponding to the search input message. In some embodiments, the search input message is the query statement search, and a node identifier that meets the condition may be queried based on the query statement. For another example, the search input message is the extended search, and a node identifier corresponding to the key message may be queried based on the key message.

Existing keyword searches are searches usually based on text matching. The searches based on the text matching are easy to search results from scripts or text files that are irrelevant to the source code.

By configuring the node identifier of the graph node to be consistent with the identification message of the code element, performing the search based on the code identification message can avoid searching some script fragments and accurately search the code element from the source code, thereby improving the search accuracy and reducing the redundant search results.

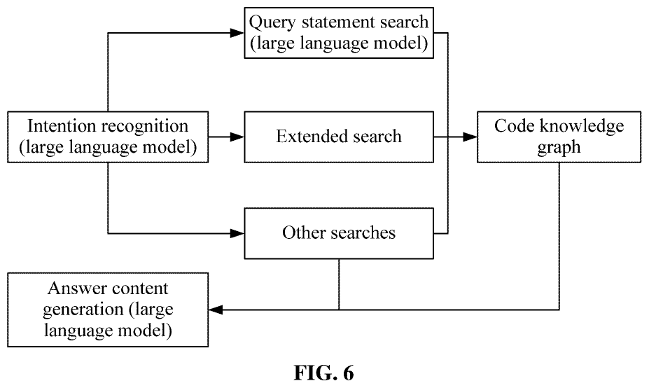

In some embodiments, a schematic diagram of a search scenario is shown in FIG. 6.

In the search stage, in the embodiment of the present disclosure, a graph search and a conventional RAG search assembly are integrated, which also makes up for the shortcomings of the vector search in processing more complex and context-related query capabilities. For different question-answer and code-generation scenarios of the client, an intention recognition model determines a request of the client and how to perform a search to obtain a sufficient context. The intention recognition model outputs the question intention, and the corresponding search type may be determined according to the question intention.
1. When the search type is the query statement search, the Text2Gremlin (LLM) may be used for converting the question message in the natural language into the query statement in the specific graph query language (such as gremlin and Cypher).
2. When the search type is the extended search, LLM may be used for performing entity recognition on the question message and rewriting, expanding, and translating the question message to acquire the key message corresponding to the question message. The functions of keyword and full-text searches are fulfilled based on the attributes of the graph nodes according to the key message.
3. When the search type is the other searches, for example, the other search types may include a server-end search, a client-end search, and a mixed search between client and server. Specifically, searches of the other search types at the server end may include a search based on conventional RAG, specifically the vector search or a keyword search. Searches of the other search types at the client end may include a local file query. Searches of the other search types of the mixed search may include that the server end provides a search range or a search condition, and the client end performs a local search based on the provided search range or the provided search condition.

The first two graph searches may be used as secondary filtering or supplements to conventional embedding (vector search) and keyword searches. The graph searches provided in the embodiment of the present disclosure can perform dependency searches at the levels of file, class, and method, and graphical search results (subgraph) and symbol (node identifier) searches.

The server end may integrate all the search results and sort the search results according to the correlation between the question message and the search results to obtain the target code knowledge. The target code knowledge is provided for LLM, and LLM generates the answer message. In addition, the graph search capability may be used independently as a supplement to the agent capability of LLM. Specifically, graph search implementation codes may be encapsulated to a certain extent and are used autonomously by LLM through tools or function invoking. Main encapsulations include the following.
1. search_method_in_class(method_name: str, class_name: str)
2. search_method_in_file(method_name: str, file_path: str)
3. Search_method(method_name: str)
4. Search_class_in_file(self, class_name, file_name: str)

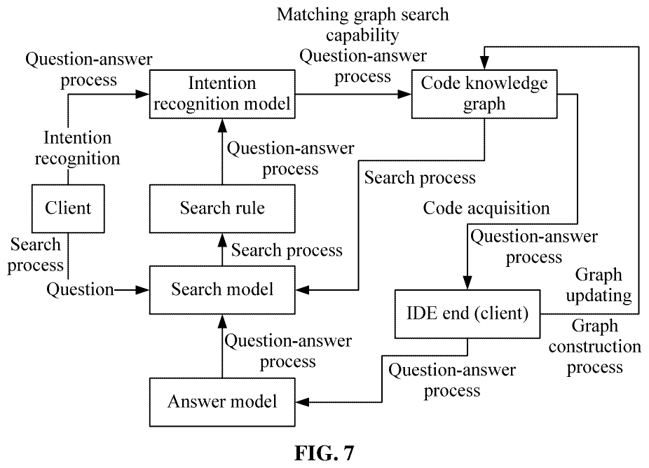

In an application scenario such as a scenario diagram of the code generation method based on the code knowledge graph as shown in FIG. 7, the question-answer process may refer to the process in which the client inputs the question message, and the current electronic device processes the question message and outputs the answer message. The search process may refer to the process in which a search model learns search capabilities and the process in which the code knowledge graph is searched. The graph construction process may refer to the process in which the code knowledge graph is constructed. It is to be noted that the question-answer process, the graph construction process, and the search process are not completely unrelated, and there is an association between the three processes.

In the graph construction process, the IDE end acquires the local source code with the target range specified by the client, generates the code tree, and sends the code tree to the server end. The server end constructs the code knowledge graph according to the code tree to implement graph updating.

In the question-answer process, the client inputs the question message (query), and the server end inputs the question message into the intention recognition model for processing to obtain the question intention. The intention recognition model matches the graph search capability according to the question intention and determines the search type. The search process is executed according to the search type. The search type may include the other searches that include a local search and the mixed search.

In the search process, the search model searches the constructed code knowledge graph according to the search input message corresponding to the search type to obtain the search results of the graph. The question-answer process is executed according to the search results.

In the question-answer process, the IDE end performs the local search according to the search type to obtain a local code, or the mixed search is executed based on the cooperation between the server end and the IDE end. Search results of the mixed search and the local search are sent to the server end. The server end integrates the search results. Specifically, the server end integrates search results of the local search, the mixed search, and the graph to form the target code knowledge. The target code knowledge and the question message are input into an answer model to generate codes corresponding to the question message.

The intention recognition model, the answer model, and the search model may all be LLMs, and prompt templates with corresponding functions are input into the LLMs to fulfill the functions of intention recognition, question and answer, and search. In addition, the search model and the intention recognition model may be independent deep learning models. The search model may continuously enrich the graph search capability based on the question message. Exemplarily, the search model may perform the query statement search, a node-level search, or a graph relationship search. For example, the query statement search may include a search of search rules. The node-level search may include the current file, a code repository (repo), a folder, a source file, and a document (doc). The graph relationship search may include a graph dependency relationship and a graph invoking relationship.

The answer model may visualize the results. Specifically, in the model generation stage, in the embodiment of the present disclosure, the quality of code generation is improved by compressing and visualizing the search results based on the richer context and association message of a model. The visualized search results specifically mean that the search results of the graph are connected in series into a subgraph. For one aspect, the subgraph may complete the missing paths in the search results and enrich a dependency message; for another aspect, the subgraph is visualized to the model and the client to improve the understanding of a code dependency relationship and the client experience.

In addition, the graph-based search results in the embodiment of the present disclosure achieve message compression. In terms of generic questions and answers and deep-level dependencies, the graph retains the original files, classes, method signatures, and invoking messages and deletes redundant annotations and the source code so that the same window model can receive richer messages; the overall code architecture is more fully understood so that the executability of model generation codes can be further improved.

In the field of code intelligence, the conventional RAG ignores the structural relationship and deep dependency messages between the elements in the source code and cannot effectively process the structural redundancy of the source code, and the plain text expression cannot fully display the structure and dependency relationships of files in the codebase. In actual applications, codes generated by the model need a lot of manual repair and adjustment before being correctly applied to the source file.

Based on this, an embodiment of the present disclosure provides a method for improving the quality of codes generated by LLM based on the code knowledge graph. Based on the fact that the codebase is naturally a “graph” of associations between the code elements, this method parses the source code to construct a knowledge graph of the entire codebase and then provides more structured, precise, and scenario-based dependency relationships and structural definition search capabilities based on the intention recognition (Router LLM) and the knowledge graph, which are integrated into the automated pipeline of the conventional RAG, making up for the shortcomings of the vector search and the keyword search and solving the limitations in the related art in processing complex programming tasks.

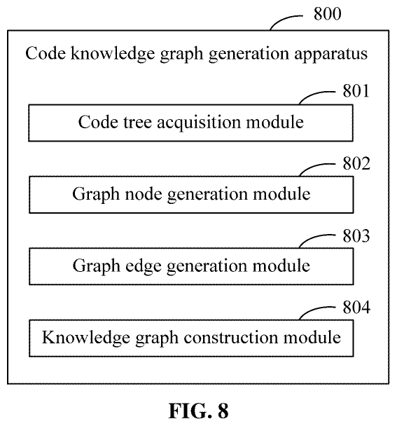

According to an embodiment of the present disclosure, FIG. 8 is a schematic diagram illustrating the structure of a code knowledge graph generation apparatus according to an embodiment of the present disclosure. The embodiment of the present disclosure is applicable to the case of constructing a knowledge graph. The apparatus is implemented as software and/or hardware and is configured in an electronic device having a certain data computing capability.

As shown in FIG. 8, the code knowledge graph generation apparatus 800 includes a code tree acquisition module 801, a graph node generation module 802, a graph edge generation module 803, and a knowledge graph construction module 804.

The code tree acquisition module 801 is configured to acquire a code tree, where the code tree includes first code elements and a structural relationship among the first code elements, where the code tree is generated by performing content parsing on a source code. The graph node generation module 802 is configured to generate at least one first graph node according to the first code elements in the code tree.

The graph edge generation module 803 is configured to generate a first graph edge between corresponding graph nodes according to the structural relationship among the first code elements in the code tree.

The knowledge graph construction module 804 is configured to generate a code knowledge graph according to the at least one graph node and edges between the at least one graph node.

According to the technical solutions of the present disclosure, the content parsing is performed on the source code, the code elements and the structural relationship are extracted from the source code, the code tree is generated based on the extracted content, and the code knowledge graph is generated based on the code tree so that the processing of the code elements and the structural relationship can be reduced, and the loss of valid data in the code knowledge graph can be reduced. Moreover, a redundant message in the source code can be deleted to streamline the code knowledge graph; the storage amount and data processing amount of the knowledge graph can be reduced, and the construction efficiency of the knowledge graph can be improved; code elements of other scopes involved in the source code can also be acquired to increase a global message, thereby increasing the integrity of the knowledge graph.

Optionally, the code knowledge graph generation apparatus further includes a description message acquisition module and a knowledge graph generation module. The description message acquisition module is configured to acquire a description message associated with the code tree.

The knowledge graph generation module is configured to add the description message to the code knowledge graph.

Optionally, the description message acquisition module includes a description node generation unit, a description node addition unit, a description element corresponding unit, a description edge generation unit, and a description edge addition unit.

The description node addition unit is configured to generate a second graph node according to the description message.

The description node addition unit is configured to add the second graph node to the code knowledge graph.

The description element corresponding unit is configured to acquire second code elements corresponding to the description message.

The description edge generation unit is configured to generate, in the code knowledge graph, a second graph edge between the second graph node and a first graph node corresponding to the second graph node.

The description edge addition unit is configured to add the second graph edge to the code knowledge graph.

Optionally, the code tree is generated by performing the content parsing on a source code with a target range specified by a client, and the target range includes a source file, a codebase, or a directory.

The preceding code knowledge graph generation apparatus can perform the code knowledge graph generation method provided in any embodiment of the present disclosure and has functional modules and beneficial effects that correspond to the performed code knowledge graph generation method.

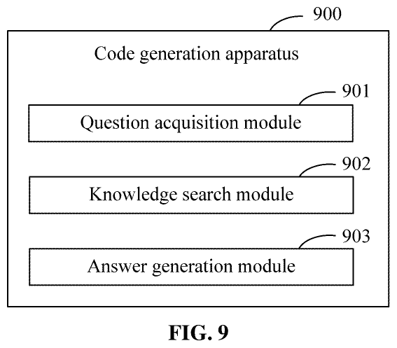

According to an embodiment of the present disclosure, FIG. 9 is a schematic diagram illustrating the structure of a code generation apparatus according to an embodiment of the present disclosure. The embodiment of the present disclosure is applicable to the case of human-computer interaction based on the knowledge graph constructed in the preceding embodiment. The apparatus is implemented as software and/or hardware and is configured in an electronic device having a certain data computing capability.

As shown in FIG. 9, the code generation apparatus 900 includes a question acquisition module 901, a knowledge search module 902, and an answer generation module 903.

The question acquisition module 901 is configured to acquire a question message.

The knowledge search module 902 is configured to perform a search in a code knowledge graph according to the question message to obtain target code knowledge, where the code knowledge graph is generated by the code knowledge graph generation method provided in any embodiment of the present disclosure.

The answer generation module 903 is configured to generate an answer message according to the target code knowledge and the question message.

According to the technical solutions of the present disclosure, the code knowledge related to the question message is searched in the constructed code knowledge graph, and the question message is processed in combination with the code knowledge to obtain the answer message; the code knowledge can be searched in the code knowledge graph that retains the original code elements and deletes the redundant message so that the limited code knowledge can include richer key messages, helping understand the overall code architecture and improving the reliability of the answer message.

Optionally, the knowledge search module 902 includes a question intention acquisition unit, a search type determination unit, a search message determination unit, and a code knowledge search unit.

The question intention acquisition unit is configured to perform intention recognition on the question message to obtain a question intention.

The search type determination unit is configured to determine the search type according to the question intention.

The search message determination unit is configured to acquire a search input message corresponding to the search type.

The code knowledge search unit is configured to perform the search in the code knowledge graph according to the search input message to obtain the code knowledge.

Optionally, the search type includes a query statement search. The search message determination unit includes a query statement generation subunit and a first input determination subunit.

The query statement generation subunit is configured to generate a query statement according to the question message, where the search input message includes the query statement.

The first input determination subunit is configured to determine the query statement as the search input message corresponding to the search type.

Optionally, the search type includes an extended search.

The search message determination unit includes a key message determination subunit and a second input determination subunit.

The key message determination subunit is configured to determine a key message according to the question message and the question intention, where the search input message comprises the key message.

The second input determination subunit is configured to determine the key message as the search input message corresponding to the search type.

Optionally, the code knowledge search unit includes a target node query subunit, a node subgraph generation subunit, and a subgraph addition subunit.

The target node query subunit is configured to perform the search in the code knowledge graph according to the search input message to obtain multiple target nodes.

The node subgraph generation subunit is configured to generate a subgraph according to the target nodes and an association relationship between the target nodes, where the target code knowledge includes the at least two target nodes and the subgraph.

The subgraph determination subunit is configured to determine the target nodes and the subgraph as the target code knowledge.

Optionally, the code generation apparatus further includes a question feedback module.

The question feedback module is configured to out the question intention, the target code knowledge, and the answer message to a user.

Optionally, the code knowledge search unit includes an identifier matching subunit.

The identifier matching subunit is configured to match the search input message with a graph node identifier of the code knowledge graph to obtain the target code knowledge, where the graph node identifier is an identification message of a code element in the source code configured to construct the code knowledge graph.

Optionally, the answer generation module 903 includes a search result sorting unit and an answer message generation unit.

The search result sorting unit is configured to sort search results included in the target code knowledge according to the question message to obtain a sorting result.

The answer message generation unit is configured to generate the answer message according to the sorting result and the question message.

Optionally, the code generation apparatus further includes a specified code tree acquisition module and a knowledge graph generation module.

The specified code tree acquisition module is configured to acquire a code tree generated based on a specified local source code while acquiring the question message input by the client.

The knowledge graph generation module is configured to acquire the code knowledge graph according to the code tree.

The preceding code generation apparatus can perform the code generation method provided in any embodiment of the present disclosure and has functional modules and beneficial effects that correspond to the performed code generation method.

In the technical solutions of the present disclosure, the collection, storage, use, processing, transmission, provision, and disclosure of client personal messages involved are in compliance with provisions of relevant laws and regulations and do not violate public order and good customs.

According to an embodiment of the present disclosure, the present disclosure further provides an electronic device, a readable storage medium, and a computer program product.

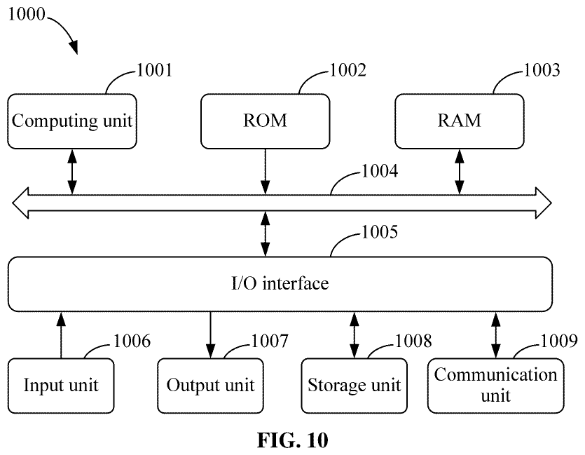

FIG. 10 is an illustrative regional diagram of an example electronic device 1000 for implementing an embodiment of the present disclosure. The electronic device is intended to represent various forms of digital computers, for example, a laptop computer, a desktop computer, a worktable, a personal digital assistant, a server, a blade server, a mainframe computer, and an applicable computer. The electronic device may also represent various forms of mobile apparatuses, for example, a personal digital assistant, a cellphone, a smartphone, a wearable device, and a similar computing apparatus. Herein the shown components, the connections and relationships between these components, and the functions of these components are illustrative and are not intended to limit the implementation of the present disclosure as described and/or claimed herein.

As shown in FIG. 10, the device 1000 includes a computing unit 1001. The computing unit 1001 may perform various types of appropriate operations and processing based on a computer program stored in a read-only memory (ROM) 1002 or a computer program loaded from a storage unit 1008 to a random-access memory (RAM) 1003. Various programs and data required for instructions of the device 1000 may also be stored in the RAM 1003. The computing unit 1001, the ROM 1002, and the RAM 1003 are connected to each other through a bus 1004. An input/output (I/O) interface 1005 is also connected to the bus 1004.

Multiple components in the device 1000 are connected to the I/O interface 1005. The components include an input unit 1006 such as a keyboard and a mouse, an output unit 1007 such as various types of displays and speakers, the storage unit 1008 such as a magnetic disk and an optical disc, and a communication unit 1009 such as a network card, a modem, and a wireless communication transceiver. The communication unit 1009 allows the device 1000 to exchange messages/data with other devices over a computer network such as the Internet and/or various telecommunications networks.

The computing unit 1001 may be various general-purpose and/or special-purpose processing components having processing and computing capabilities. Examples of the computing unit 1001 include, but are not limited to, a central processing unit (CPU), a graphics processing unit (GPU), a special-purpose artificial intelligence (AI) computing chip, a computing unit executing machine learning models and algorithms, a digital signal processor (DSP), and any appropriate processor, controller and, microcontroller. The computing unit 1001 performs the various methods and processing described in the preceding, such as the code knowledge graph generation method or the code generation method. For example, in some embodiments, the code knowledge graph generation method or the code generation method may be implemented as a computer software program tangibly contained in a machine-readable medium such as the storage unit 1008. In some embodiments, part or all of computer programs may be loaded and/or installed on the device 1000 via the ROM 1002 and/or the communication unit 1009. When a computer program is loaded to the RAM 1003 and executed by the computing unit 1001, one or more steps of the code knowledge graph generation method or the code generation method may be executed. Alternatively, in other embodiments, the computing unit 1001 may be configured, in any other suitable manner (for example, by means of firmware), to perform the code knowledge graph generation method or the code generation method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Program codes for implementation of the methods of the present disclosure may be written in one programming language or any combination of multiple programming languages. These program codes may be provided for a processor or controller of a general-purpose computer, a special-purpose computer, or another programmable data processing apparatus to enable functions/operations specified in flowcharts and/or regional diagrams to be implemented when these program codes are executed by the processor or controller. The program codes may be executed entirely on a machine, partly on a machine, as a stand-alone software package, partly on a machine and partly on a remote machine, or entirely on a remote machine or a server.

In the context of the present disclosure, the machine-readable medium may be a tangible medium that may include or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium include an electrical connection based on one or more wires, a portable computer disk, a hard disk, a random-access memory (RAM), a read-only memory (ROM), an erasable programmable read-only memory (EPROM) or a flash memory, an optical fiber, a portable compact disc read-only memory (CD-ROM), an optical storage device, a magnetic storage device, or any appropriate combination thereof.

In order that interaction with a client is provided, the systems and techniques described herein may be implemented on a computer. The computer has a display device (for example, a cathode-ray tube (CRT) or a liquid-crystal display (LCD) monitor) for displaying a message to the client and a keyboard and a pointing apparatus (for example, a mouse or a trackball) through which the client can provide input to the computer. Other types of devices may also be used for providing interaction with a client. For example, feedback provided for the client may be sensory feedback in any form (for example, visual feedback, auditory feedback, or haptic feedback). Moreover, input from the client may be received in any form (including acoustic input, voice input, or haptic input).

The systems and techniques described herein may be implemented in a computing system including a back-end component (for example, a data server), a computing system including a middleware component (for example, an application server), a computing system including a front-end component (for example, a client computer having a graphical client interface or a web browser through which a client can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

A computer system may include client ends and servers. A client end and a server are generally remote from each other and typically interact through a communication network. The relationship between the client ends and the servers arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS). The server may also be a server of a distributed system, or a server combined with a blockchain.

Artificial intelligence is a discipline studying the simulation of certain human thinking processes and intelligent behaviors (such as learning, reasoning, thinking, and planning) by a computer and involves techniques at both hardware and software levels. Hardware techniques of artificial intelligence generally include techniques such as sensors, special-purpose artificial intelligence chips, cloud computing, distributed storage, and big data processing. Software techniques of artificial intelligence mainly include several major directions such as computer vision technology, speech recognition technology, natural language processing technology, machine learning/deep learning technology, big data processing technology, and knowledge graph technology.

Cloud computing refers to a technical system that accesses a shared elastic-and-scalable physical or virtual resource pool through a network, where resources may include servers, instruction systems, networks, software, applications, and storage devices and may be deployed and managed in an on-demand, self-service manner. Cloud computing can provide efficient and powerful data processing capabilities for model training and technical applications such as artificial intelligence and blockchain.

It is to be understood that various forms of the preceding flows may be used with steps reordered, added, or removed. For example, the steps described in the present disclosure may be executed in parallel, in sequence, or in a different order as long as the desired results of the technical solutions provided in the present disclosure are achieved. The execution sequence of these steps is not limited herein.

The scope of the present disclosure is not limited by the preceding embodiments. It is to be understood by those skilled in the art that various modifications, combinations, sub-combinations, and substitutions may be made according to design requirements and other factors. Any modification, equivalent substitution, and improvement made within the spirit and principle of the present disclosure is within the scope of the present disclosure.

What is claimed is:

1. A code knowledge graph generation method, comprising:
acquiring a code tree comprising first code elements and a structural relationship among the first code elements, wherein the code tree is generated by performing content parsing on a source code;
generating, based on the first code elements, at least one first graph node ;
generating, based on the structural relationship, a first graph edge between corresponding graph nodes; and
generating, based on the at least one first graph node and the first graph edge, a code knowledge graph.

2. The code knowledge graph generation method according to claim 1, further comprising:
acquiring a description message associated with the code tree; and
adding the description message to the code knowledge graph.

3. The code knowledge graph generation method according to claim 2, wherein adding the description message to the code knowledge graph comprises:
Generating, based on the description message, a second graph node ;
adding the second graph node to the code knowledge graph;
acquiring a second code element corresponding to the description message;
generating, in the code knowledge graph, a second graph edge between the second graph node and a first graph node corresponding to the second graph node; and
adding the second graph edge to the code knowledge graph.

4. The code knowledge graph generation method according to claim 1, wherein the code tree is generated by performing the content parsing on the source code with a specified target range, and the specified target range comprises a source file, a codebase, or a directory.

5. A code generation method, comprising:
acquiring an input question message;
performing a search in a code knowledge graph based on the input question message to obtain target code knowledge, wherein the code knowledge graph is generated by the code knowledge graph generation method according to claim 1; and
generating an answer message based on the target code knowledge and the input question message.

6. The code generation method according to claim 5, wherein performing the search in the code knowledge graph comprises:
performing intention recognition on the input question message to obtain a question intention;
determining a search type based on the question intention;
acquiring a search input message corresponding to the search type; and
performing the search in the code knowledge graph based on the search input message to obtain the target code knowledge.

7. The code generation method according to claim 6, wherein the search type comprises a query statement search; and
wherein acquiring the search input message corresponding to the search type comprises:
generating a query statement based on the question message, wherein the search input message comprises the query statement.

8. The code generation method according to claim 6, wherein the search type comprises an extended search; and
wherein acquiring the search input message corresponding to the search type comprises:
determining a key message based on the question message and the question intention, wherein the search input message comprises the key message.

9. The code generation method according to claim 8, wherein performing the search in the code knowledge graph comprises:
performing the search in the code knowledge graph based on the search input message to obtain at least two target nodes; and
generating a subgraph based on the at least two target nodes and an association relationship between the at least two target nodes,
wherein the target code knowledge comprises the at least two target nodes and the subgraph.

10. The code generation method according to claim 8, further comprising:
outputting the question intention, the target code knowledge, and the answer message.

11. The code generation method according to claim 6, wherein performing the search in the code knowledge graph comprises:
matching the search input message with a graph node identifier of the code knowledge graph to obtain the target code knowledge, wherein the graph node identifier is an identification message of a code element in the source code configured to construct the code knowledge graph.

12. The code generation method according to claim 5, wherein generating the answer message comprises:
sorting search results comprised in the target code knowledge based on the question message to obtain a sorting result; and
generating the answer message based on the sorting result and the question message.

13. The code generation method according to claim 5, further comprising:
acquiring a code tree generated based on a specified local source code; and
acquiring the code knowledge graph based on the code tree.

14. An electronic device, comprising:
at least one processor; and
a memory communicatively connected to the at least one processor,
wherein the memory is configured to store instructions executable by the at least one processor to cause the at least one processor to perform:
acquiring a code tree comprising first code elements and a structural relationship among the first code elements, wherein the code tree is generated by performing content parsing on a source code;
generating, based on the first code elements, at least one first graph node ;
generating, based on the structural relationship, a first graph edge between corresponding graph nodes; and
generating, based on the at least one first graph node and the first graph edge, a code knowledge graph.

15. The electronic device according to claim 14, wherein the memory is configured to store instructions executable by the at least one processor to cause the at least one processor to perform:
acquiring a description message associated with the code tree; and
adding the description message to the code knowledge graph.

16. The electronic device according to claim 15, wherein the memory is configured to store instructions executable by the at least one processor to cause the at least one processor to perform adding the description message to the code knowledge graph by:
generating a second graph node based on the description message;
adding the second graph node to the code knowledge graph;
acquiring a second code element corresponding to the description message;
generating, in the code knowledge graph, a second graph edge between the second graph node and a first graph node corresponding to the second graph node; and
adding the second graph edge to the code knowledge graph.

17. The electronic device according to claim 14, wherein the code tree is generated by performing the content parsing on the source code with a specified target range, and the specified target range comprises a source file, a codebase, or a directory.

18. An electronic device, comprising:
at least one processor; and
a memory communicatively connected to the at least one processor,
wherein the memory is configured to store instructions executable by the at least one processor to cause the at least one processor to perform the code knowledge graph generation method according to claim 5.

19. A non-transitory computer-readable storage medium storing computer instructions configured to cause a computer to perform the code knowledge graph generation method according to claim 1.

20. A non-transitory computer-readable storage medium storing computer instructions configured to cause a computer to perform the code knowledge graph generation method according to claim 5.
